(19) United States
(12) Patent Application Publication
(10) Pub. No.: US 2026/0085428 A1
(43) Pub. Date: Mar. 26, 2026

(54) DARK FINISH CHARGING CONTACT AND CONNECTOR THROUGH PVD COATING WITH ALLOYING/DOPING

(71) Applicant: Meta Platforms Technologies, LLC, Menlo Park, CA (US)

(72) Inventors: Jianer Bao, Sunnyvale, CA (US); Yang Li, Seattle, WA (US); Isaac Finger, Sunnyvale, CA (US); Karson Shadley, Seattle, WA (US); Samaneh Sharifi Golru, Sunnyvale, CA (US); Erika Kelter, Seattle, WA (US); Jinsong Tian, Shanghai (CN)

(21) Appl. No.: 19/264,733

(22) Filed: Jul. 9, 2025

(30) Foreign Application Priority Data
Sep. 24, 2024 (WO) PCT/CN2024/120554

(51) Int. Cl. C23C 28/00; G02C 5/02; H01R 13/03; H01R 43/16

(52) U.S. Cl. CPC C23C 28/343; H01R 13/03; H01R 43/16; G02C 5/02

(57) ABSTRACT

A method of the subject technology includes creating a dark finish coating on charging contacts of a device by reducing Schottky junctions at an interface of a metal substrate and the dark finish coating, as well as between the charging contacts of device and charger. The Schottky junctions are formed at a semiconductor-metal interface and reducing the Schottky junction is accomplished through co-deposition during a physical vapor deposition (PVD) process.

### CROSS REFERENCE TO RELATED APPLICATIONS

The present disclosure is related and claims priority under 35 USC § 119 (a)-(d) and (f) to PCT/CN2024/120554 entitled “DARK FINISH CHARGING CONTACT AND CONNECTOR THROUGH PVD COATING WITH ALLOYING/DOPING,” filed on Sep. 24, 2024, the contents of which are herein incorporated by reference, in their entirety, for all purposes.

### TECHNICAL FIELD

The present disclosure generally relates to electrical contacts, and more particularly, to a dark finish charging contact and connector through physical vapor deposition (PVD) coating with alloying and/or doping.

### BACKGROUND

Charging contacts and connectors in consumer electronics (CE) devices typically need high corrosion resistance against corrosive material (e.g., sweat, salt, various chemicals, etc.) and low contact resistance, such as from 30 milli Ohm (mΩ) to 200 mΩ at a low contact force. Hence, the noble metal finishes on top of copper alloys are the most common designs. This leads to very limited options for cosmetic finishes such as silver and gold finishes. For aesthetic reasons, black/dark finish charging contacts and connectors are the most sought-after finish color for charging and connector applications. There are only a few black metal options available, such as black nickel (Ni) and black ruthenium (Ru).

However, black Ni has poor corrosion resistance and bio-compatibility issues. Black Ru also suffers from low corrosion resistance problem. There are conductive PVD options such as aluminum-titanium-nitride (Al—Ti—N), chromium-silicon-carbon-nitride (Cr—Si—C—N), chromium carbide (Cr—C), diamond-like carbon (DLC) and/or titanium carbide (Ti—C), titanium nitride (Ti—N) and the like with various colors including black. However, even though some of the materials are very conductive, they are usually not conductive enough for charging contact/connector applications, and so far, have not been used in the industry.

### SUMMARY

According to some aspects, a method of the subject technology includes creating a dark finish coating on charging contacts of a device by reducing Schottky junctions at an interface of a metal substrate and the dark finish coating, as well as between the charging contacts of the device and charger. The Schottky junction is forms at a semiconductor-metal interface, and reducing the Schottky junction is accomplished through using co-deposition during a physical vapor deposition (PVD) process.

According to other aspects, a device of the subject technology includes a charging area including dark finish charging contacts consisting of a reduced Schottky junction at a semiconductor-metal interface. The Schottky junction is reduced by using co-deposition during a PVD process, and the dark finish charging contact includes DLC and/or tetrahedral amorphous carbon (TaC) (DLC/TaC) for a low junction barrier height.

According to yet other aspects, a method of the subject technology includes creating a dark finish on charging contacts of a device by reducing a semiconductor-metal interface that is Schottky junctions at an interface of a metal substrate and the dark finish coating, as well as between the charging contacts of the device and a charger by using a PVD process including a co-deposition. The co-deposition includes one of alloying or doping, and alloying comprises using Ti.

### BRIEF DESCRIPTION OF THE DRAWINGS

To easily identify the discussion of any particular element or act, the most significant digit or digits in a reference number refer to the figure number in which that element is first introduced.

FIGS. 1A and 1B are schematic diagrams illustrating examples of Schottky junctions, as discussed herein.

FIG. 2 is a chart illustrating example ranges of contact resistance of an existing conductive DLC/TaC, as discussed herein.

FIG. 3 is a chart illustrating example ranges of contact resistance of a DLC/TaC produced with an improved process, according to certain aspects of the disclosure.

FIG. 4 is a chart illustrating example ranges of contact resistance of a DLC/TaC produced with a further improved process and material, according to certain aspects of the disclosure.

FIG. 5 is a chart illustrating example ranges of contact resistance of a new design using a Ti alloying strategy to improve the dynamic contact resistance (DCR) at the reverse polarity, according to certain aspects of the disclosure.

FIG. 6 is a chart illustrating an example of plots of the current-voltage behavior of a contact according to some aspects of the disclosure.

FIG. 7 is a schematic diagram illustrating an example of a pair of smart glasses, according to some aspects of the subject technology.

FIG. 8 is a flow diagram illustrating a method of producing a dark finish contact, according to some aspects of the subject technology.

FIG. 9 is a flow diagram illustrating a method of producing a dark finish contact, according to some aspects of the subject technology.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

Some aspects of the subject disclosure are directed to a dark finish charging contact and connector produced through PVD coating with alloying and/or doping. In some aspects, the disclosed solution resolves issues with the existing solutions by using a PVD DLC/TaC through alloying with Ti, as discussed herein.

There are two main root causes why the PVD coating that can provide more color options is not suitable for charging contact applications, for which the subject disclosure presents resolutions to address from the fundamental material property aspect. The first root cause is that most connectors use bronze and brass as substrate material, which are prone to corrosion unless protected by layers of noble metals. PVD coating on copper alloys typically leads to poor corrosion resistance and would not be suitable for demanding connector applications. The second cause is that PVD coatings are usually not conductive enough due to presence of not-so-conductive semiconductors typically having a large bandgap and even insulating ceramic materials to enhance abrasion resistance and achieve a colored finish. For example, a typical dark finish is comprised of Cr, tungsten (W) and C (Cr—W—C), which can form insulating carbide materials. A dark chrome finish may have some fraction of Cr plus chromium nitride (Cr2N) phase, and the Cr2N is known to not be a good electrical conductor.

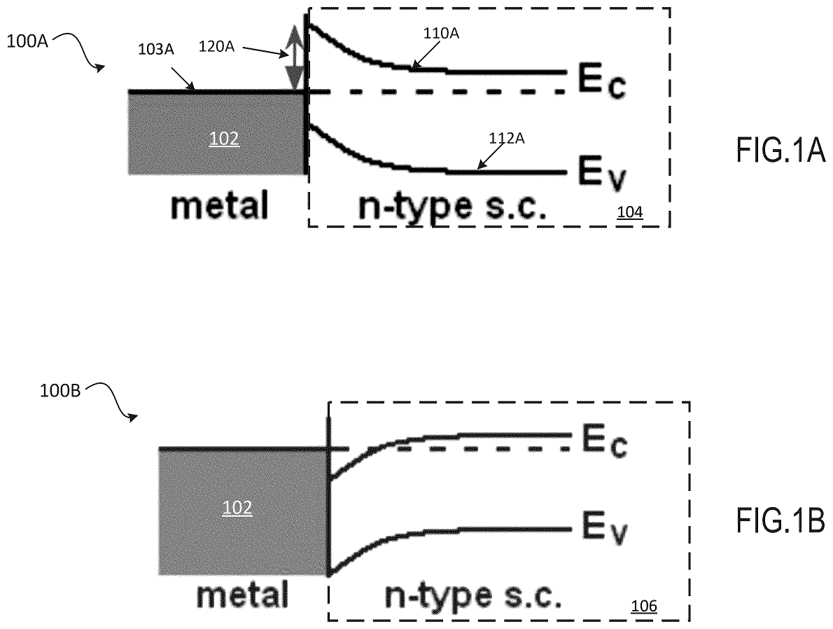

Some PVD materials such as titanium nitride (TiN) are quite conductive, for example, with a resistivity as low as a few tens of μΩ-cm. However, when in contact with a metal, there is presence of a Schottky junction at the metal/semiconductor interface, which can lead to much higher contact resistance in one direction than the other direction. This directional change of contact resistance depends on whether the PVD coating is n-type or p-type, as discussed herein with respect to FIGS. 1A and 1B below.

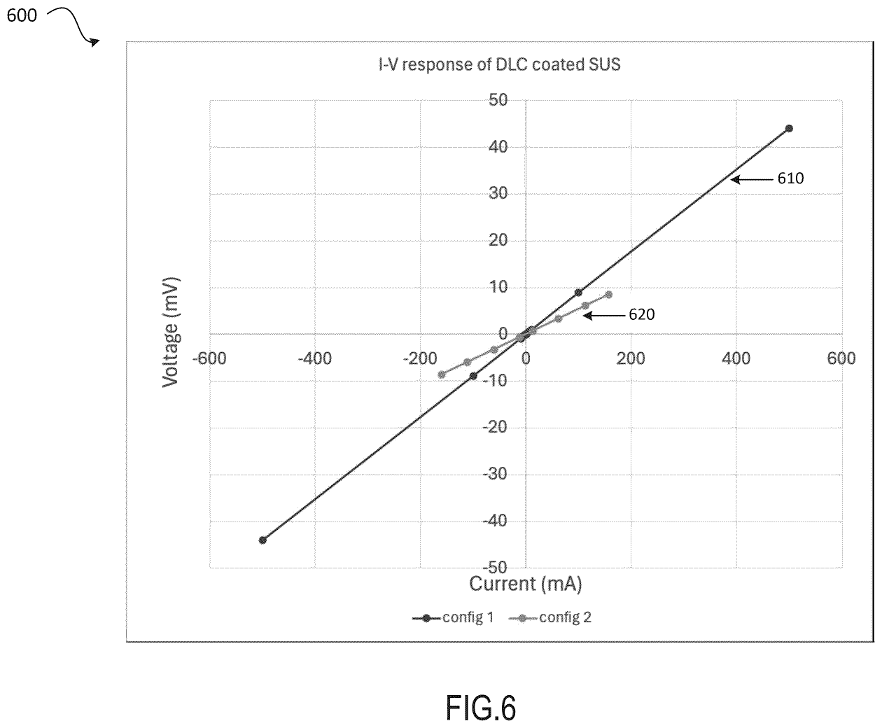

There is also another type of PVD coating that has a relatively high resistance but a low band gap, such as DLC and/or tetrahedral amorphous carbon (TaC) (DLC/TaC), which has a resistivity from a few mΩ-cm to a few tens of mΩ-cm, in presence of a high fraction of graphite, and a very low bandgap of about 12 meV. This makes the Schottky junction height much lower when in contact with metal. With some elemental doping and alloying through co-deposition during the PVD process, not only could the intrinsic material resistance be much reduced, but also the Schottky junction height could be reduced to be almost negligible, leading to a low dependency on voltage polarity, as well as close to linear current-voltage behavior similar to an ohmic contact (see FIG. 6, for example).

With respect to corrosion performance, high corrosion resistant stainless-steel materials such as SUS 300 series or SUS 900 series are preferred options to be coated with the PVD coating process. However, doping and alloying in the PVD film needs to be carefully done with the right element and amount, as well as the deposition condition. Otherwise, there could be high color variation from batch to batch and within a batch, or appreciable chemistry and microstructure changes that could lead to undesirable outcomes. Examples of alloying elements and dopants include, but are not limited to, Ti, Si, Cr, V, N, F, O, Al. The amount of dopant could be within the range of ppm to 20%, preferably less than a few percent, to avoid formation of carbide. Deposition condition also needs to be tuned to avoid the formation of carbide. Dopant/alloying elements are not limited to one in the design, and one or more dopant/alloying elements could be deposited at the same time or in sequence.

In some implementations, the subject disclosure resolves these issues by using PVD DLC/TaC through alloying with Ti, as described in more details herein. In all the samples, the color L* value is within the range of about 50-60, with most samples having an L* value of around 52-55, and a* b* within a range of about 0-5. However, the color options can also be potentially increased through either material microstructural tuning, alloying/doping element type and amount, thin (<100 nm) decorative layer on top, or interference coating design with layered DLC/TaC to expand color options. Regarding the L* and a* and b*, the lightness value, L*, also referred to as “Lstar,” defines black at 0 and white at 100; while a* and b* represent chromaticity with no specific numeric limits. Negative a* is associated with color green, positive a* is associated with red, negative b* is associated with blue and positive b* is associated with yellow.

It is to be noted that the subject technology is mainly targeted for communication and/or connection between devices and/or parts that are physically in contact, for example, through electromechanical interaction of contacts and connectors. In the wearable CE industry, this type of connection can be used to connect a device to a charger, for example, a smart glass or an ear-set put inside a charging case, in a USB connector or a detachable smart band such as an electromyography (EMG) band to connect to a watch capsule. In these CE applications, contact resistance of the contacts and/or connectors has to be low as the device is usually powered by a rechargeable battery with a voltage level less than 5V. Resistance range has to be below a few hundred mΩ, in most cases, below about 200 mΩ, and in the low-force range such as 100 gf. Thus, almost all the coating material used for this type of application in CE industry are noble metals such as Au, Pt, Pd, Rh, Rh-Ru, and through plating (except for a few cheap products using non-noble metals). So far, there is no durable dark finish either. The subject technology enables developing a dark coating that is a non-metal coating through a non-plating process.

The subject technology could also be used for some cosmetic components that also have grounding needs. For example, the hinge of smart glasses, which often is used to connect temple arm and frames has circuit through it. It can be used for electrical grounding or conduction purposes. Having a premium finish meanwhile that is very conductive makes grounding much easier.

The subject solution does not use alloy metals. The DLC of the subject solution is mainly comprised of a narrow bandgap semiconductor, which is quite conductive. Furthermore, in order to reduce the Schottky junction between a metal and a semiconductor when they come into contact with each other, which will increase the contact resistance heavily in one direction, doping and alloying are applied to the semiconductor. With the disclosed design, the subject technology is able to successfully reduce the contact resistance for both directions by about 10 times and make it feasible for contact and connector applications.

Turning now to the figures, FIGS. 1A and 1B are schematic diagrams illustrating examples of Schottky junctions 100A and 100B, as discussed herein. FIG. 1A depicts Schottky junction 100A formed at an interface of a metal 102 and an n-type semiconductor 104 (e.g., n-type). In Schottky junction 100A, on the metal side an energy level 103A is associated with free electrons in the metal 102, and on the semiconductor side, energy levels 110A (E_{C}) and 112A (E_{V}) are associated with conduction band and valence bands of the n-type semiconductor 104. The energy difference between E_{C} and E_{V} is referred to as the bandgap. The height of a junction barrier 120A between the energy level 103A and EV is dependent on the doping level of the n-type semiconductor 104. In Schottky junction 100A, the height of the barrier can be changed by applying a bias voltage across the junction between the metal 102 and the n-type semiconductor 104. To facilitate electrons flow from the n-type semiconductor 104 to the metal 102, for instance, when the metal 102 is biased positive with respect to the n-type semiconductor 104 (e.g., biased in forward direction). However, in reversed direction, electron flow will see more barrier at the Schottky junction.

FIG. 1B shows a case where the barrier height between the metal 102 and the semiconductor 106 is reduced or the junction width is made narrower through heavy doping of the semiconductor 106, both of which can help reduce resistance at the junction. This directionality can change if a p-type semiconductor is employed instead of the n-type semiconductor. Similar junctions having similar barrier height can be formed at the interface of a semiconducting PVD material deposited over a metal substrate and can also be formed at the interface of two connectors when a metal mating part is connected to another electrical connector coated with a semiconducting PVD material.

The Schottky junction barrier height is dependent on the semiconductor material band gap. If the Schottky junction barrier is too high (e.g., in nitride and carbide families, such as TiN, having a bandgap within the range of 3.35-3.45 eV), there could be a high contact resistance and also a high delta in directional resistance, which can result in a non-linear current-voltage behavior that can be hard to overcome. This makes high Schottky junction barrier materials unsuitable for applications requiring high energy efficient (EE) performance.

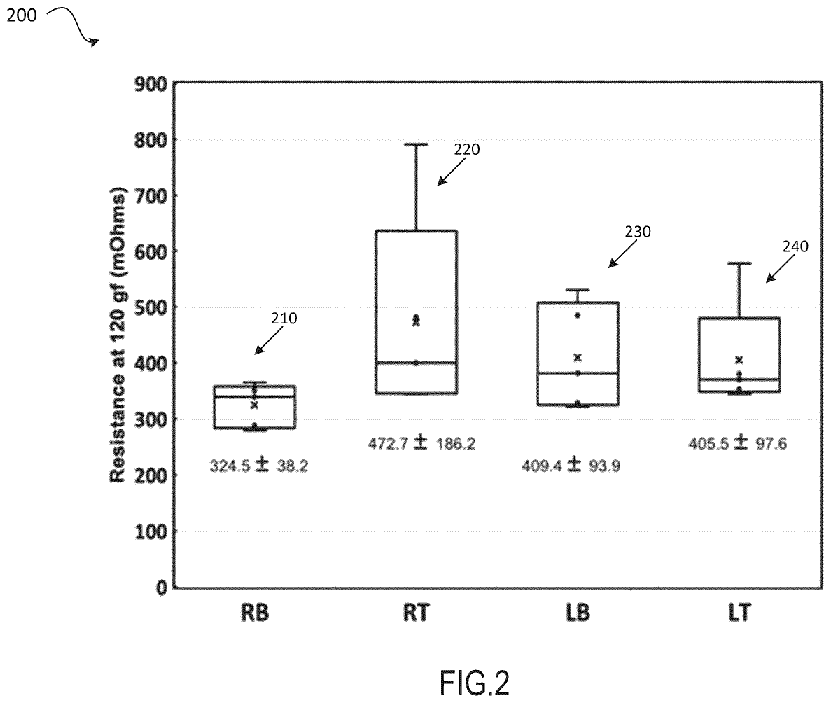

FIG. 2 is a chart 200 illustrating example ranges of contact resistance of an existing conductive DLC/TaC, as discussed herein. The resistance noted in chart 200 is measured by bringing two electrical connectors in contact with each other at a force level of 120 gf, one having a noble metal Au finish typical of a connector, and the other one having stainless steel 316 coated with conductive DLC/TaC available in the market. Each end is soldered with two electrical wires to make 4-probe measurement. It should be noted that the intrinsic material resistivity of DLC/TaC rich in graphite is about 20 mΩ-cm, yet even in the favored forward direction, having a resistance within a range of about 300-800 mΩ, is still not conductive enough for charging contact applications that typically requires a few tens mΩ up to a few hundred mΩ depending on battery size and charging current. The contact resistance ranges 210, 220, 230 and 240 respectively correspond to right bottom (RB), right top (RT), left bottom (LB) and left top (LT) of the contact area.

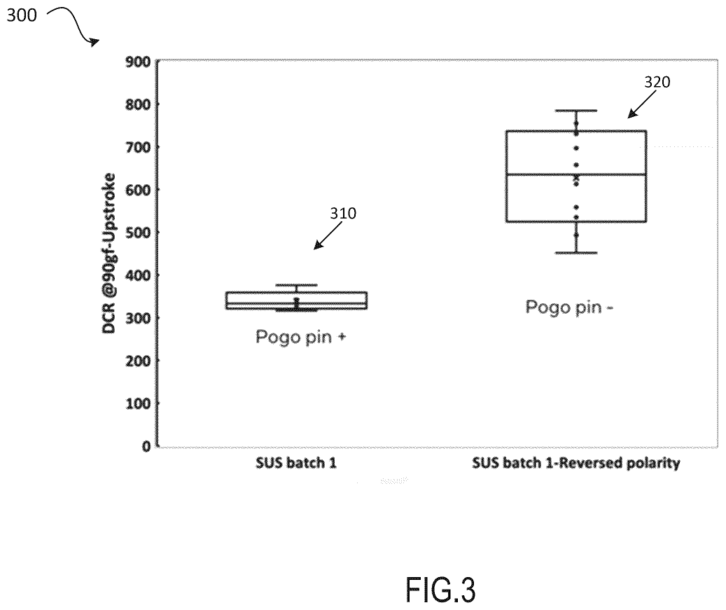

FIG. 3 is a chart 300 illustrating example ranges of contact resistance of a DLC/TaC produced with an improved process, according to certain aspects of the disclosure. The improved process includes a process tuning to get more conductive graphite in the DLC/TaC film. Resistance DCR, dynamic contact resistance, is measured at 90 gf between a noble metal coated connector and a DLC/TaC coated stainless steel (SUS) sample. Note, DCR decreases with increasing contact force until it saturates. DCR is measured with both polarity of current flow direction. In the forward direction (metal pogo pin is positive), values of range 310 of DCR are seen to be less than about 400 mΩ, significantly reduced from that shown in FIG. 2. However, in the reverse direction (metal pogo pin is negative), values of range 320 of DCR are significantly higher, showcasing the impact of Schottky junction at the metal/semiconductor interface. Most of the DLC/TaC coatings in the market have some fraction of C—H or diamond and hence are not desirably conductive even in the forward direction.

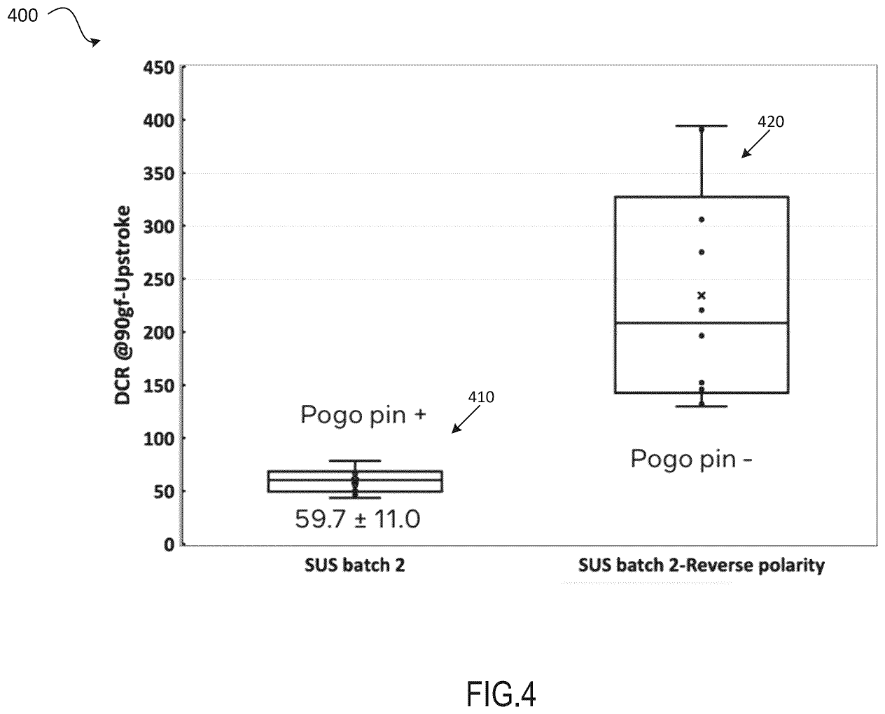

FIG. 4 is a chart 400 illustrating example ranges of contact resistance of a DLC/TaC produced with a further improved process and material, according to certain aspects of the disclosure. The further improved process is through material and process tuning to maximize the conductive graphite in the DLC/TaC film. Yet significant delta in values of range 410 of DCR in the forward direction and in values of range 420 of DCR in the reverse direction still exists, which makes this contact resistance not suitable for electrical contacts where current can flow in both directions.

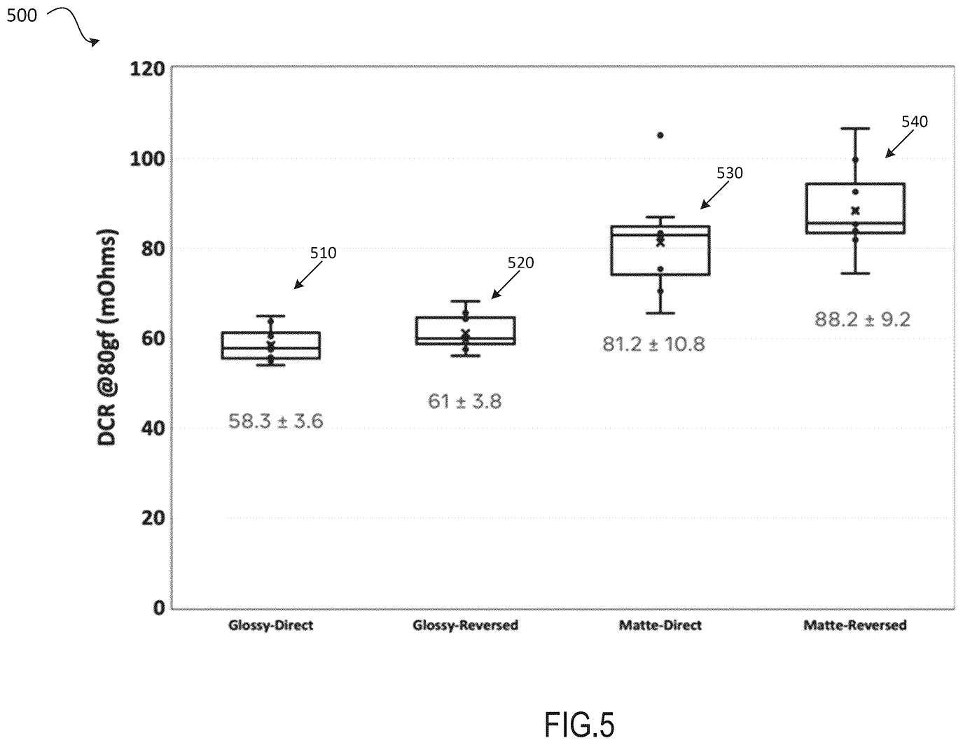

FIG. 5 is a chart 500 illustrating example ranges of contact resistance of a new design using a Ti alloying strategy to improve the DCR at the reverse polarity, according to certain aspects of the disclosure. In this case, both glossy and matte finish were tested in direct and reverse polarities as both finishes could be used for products. The DCR ranges 510, 520, 530 and 540 respectively correspond to glossy-finished directly-biased (Glossy-Direct), glossy-finished reverse-biased (Glossy-Reversed), matte-finished directly-biased (Matte-Direct) and matte-finished reversed-biased (Matte-Reversed) contacts.

As the DCR data shows, the delta in DCR between forward and reverse direction is significantly reduced, to almost negligible, demonstrating the feasibility of the disclosed concept. Stack design for this case includes, but is not limited to, SUS 316 substrate, Ti adhesion layer, Ti alloyed DLC/TaC, and a thin layer of DLC/TaC at the top for lower darkness. Adhesion layer is not limited to Ti and could include Cr, Ni, Al, Si, etc., or a combination thereof. Typical thickness is within a range of about 100 nm +/−20 nm but could be from 20 nm to 500 nm. In the alloying layer, a range of Ti to DLC/TaC ratio could be used, which, theoretically, could be within a range from 0.01 percent to a few tens percent atomically. More realistically for PVD deposition conditions, the amount of Ti could be within a range of a few atomic percent to a few tens atomic percent. Other alloying elements/dopants, as previously mentioned, could also be used. Different ratios and different elements could offer different levels of darkness and gloss. Thickness could range from 100 nm to a few microns. Top, optional DLC/TaC layer could be from 100 nm up to 2 μm. Other conductive PVD coatings such as Cr+Cr2N, Ti—O—N, Ti+TiN, or mixtures of other metal and metal nitrides, could also be added at the top for different color options provided thickness is low (up to a few hundred nm for low contact force connectors but could be thicker if contact force is higher). When the top coating layer is thin enough (e.g., a few hundred nm), the mating end can penetrate the top layer and get in contact with the alloyed/doped layer under force to make a desirable conduction path.

FIG. 6 is a chart 600 illustrating an example of plots of the current-voltage behavior of a contact according to some aspects of the disclosure. The chart 600 includes plots 610 and 620 for two different configurations, which show near-linear relationships in current and voltage. The plots 610 and 620 represent junctions of a heavily doped (config.1) or alloyed semiconductor (config.2) with a metal, respectively. The contact resistance in both plots is seen to be close to an ohmic contact such as a metal-metal contact, which is preferred for electrical connector applications.

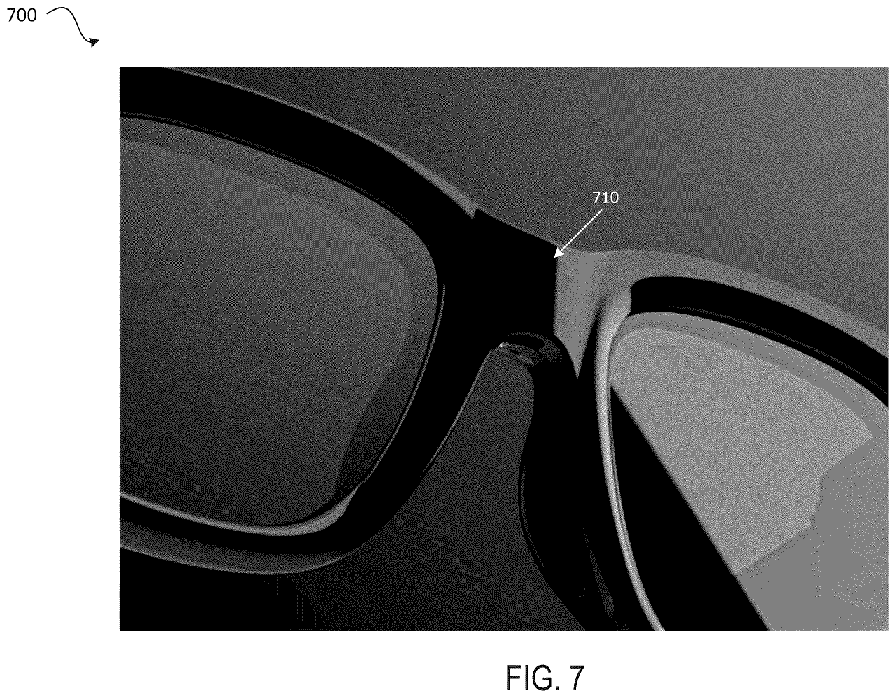

FIG. 7 is a schematic diagram illustrating an example of a pair of smart glasses 700 having dark finish charging, according to some aspects of the subject technology. The pair of smart glasses 700 is just an example of the technologies including mixed reality (MR) devices that can use the dark charging contact of the subject technology. The glasses charging contact at the nose-bridge 710 is part of the glasses cosmetic finish and could impact user's perception of the product aesthetics. Location could also include temple arm of the glasses or other areas.

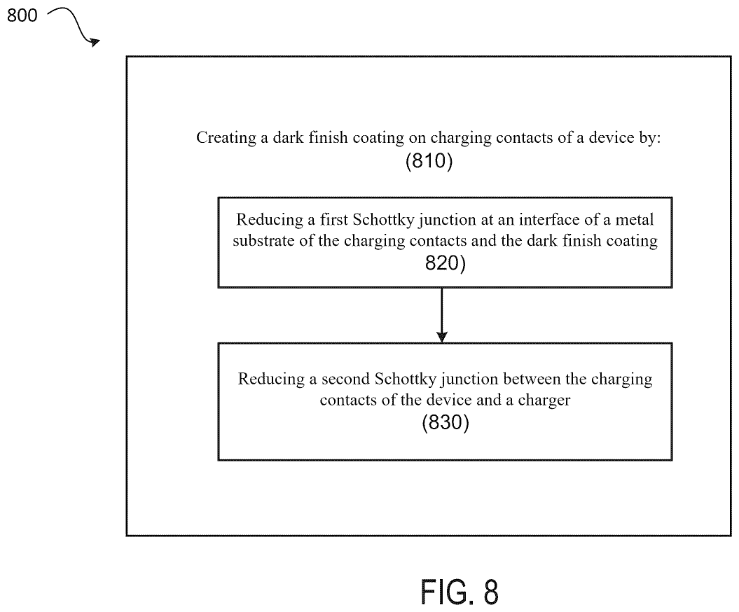

FIG. 8 is a flow diagram illustrating method 800 of producing a dark finish contact, according to some aspects of the subject technology. Method 800 includes steps 810 and 820.

In step 810, a dark finish charging contact is formed on charging contacts of a device (e.g., 700 of FIG. 7) by performing the steps 820 and 830.

In step 820, a first Schottky junction (e.g., 100A of FIG. 1A) an interface of a metal substrate (e.g., 102 of FIG. 1A) of the charging contacts and the dark finish coating is reduced. In step 820, a second Schottky junction between the charging contacts of the device and a charger is reduced.

The first Schottky junction and the second Schottky junction include a semiconductor-metal interface, and reducing the first Schottky junction and the second Schottky junction includes using co-deposition during a physical vapor deposition (PVD) process.

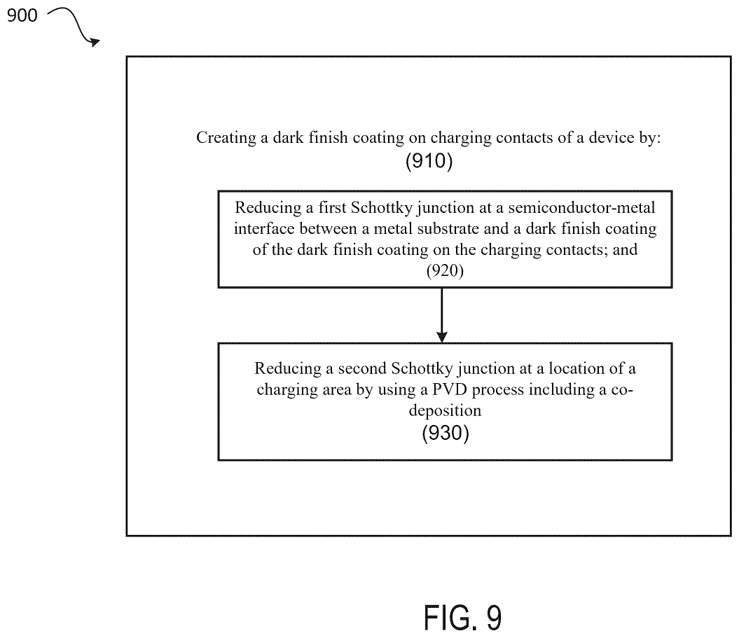

FIG. 9 is a flow diagram illustrating method 900 of producing a dark finish contact, according to some aspects of the subject technology. The method 900 includes steps 910, 920 and 930.

In step 910, a dark finish contact is formed on charging contacts of a device (e.g., 700 of FIG. 7) by performing steps 920 and 930.

In step 920, a first Schottky junction (e.g., 100A of FIG. 1A) at a semiconductor-metal interface between a metal substrate (e.g., 102 of FIG. 1A) and a dark finish coating of the dark finish coating on the charging contacts is reduced.

In step 930, a second Schottky junction at a location of a charging area is reduced by using a PVD process including a co-deposition. The co-deposition includes one of alloying or doping, and alloying comprises using Ti.

An aspect of the subject technology is directed to a method including creating a dark finish for charging contacts on a device by reducing a Schottky junction at the metal substrate and dark finish coating interface, as well as between the charging contacts of the device and a charger. The Schottky junction is formed at a semiconductor-metal interface, and reducing the Schottky junction is accomplished using co-deposition during a physical vapor deposition (PVD) process.

In some implementations, the device comprises a mixed reality (MR) device including a pair of smart eyeglasses.

In one or more implementations, the location of the charging area includes a nose-bridge of a pair of smart eyeglasses.

In some implementations, the co-deposition during the PVD process includes one of alloying or doping.

In one or more implementations, the alloying comprises using titanium (Ti) to improve the dynamic contact resistance (DCR) in a reverse polarity.

In some implementations, alloying using the Ti is to result in forming the dark finish charging contact with a color L* values within a range of about 45-70.

In one or more implementations, the alloying using the Ti is to result in forming the dark finish charging contact with an a* b* chromaticity value within a range of about −5-10.

In some implementations, the dark finish charging contact includes diamond-like carbon (DLC) and/or tetrahedral amorphous carbon (TaC) to enable formation of a small Schottky junction at the semiconductor-metal interface that could be further reduced/minimized.

In one or more implementations, the method further includes expanding color options for the dark finish charging contact through one of a material color tuning or an interference coating process.

In some implementations, the method further includes performing the interference coating process including layered DLC/TaC deposition.

In one or more implementations, the method further includes reducing a delta in DCR between a forward direction and a reverse direction of the Schottky junction to nearly zero by depositing DLC/TaC via a PVD process through alloying with Ti.

In some implementations, the method further includes increasing corrosion resistance of the dark finish charging contact by depositing DLC/TaC via a PVD process through alloying with Ti.

In one or more implementations, the increased corrosion resistance comprises resistance to sweat for a period longer than about 360 hours, and resistance to wet charging for a period up to 1 hour.

Another aspect of the subject technology is directed to a device including a charging area including a dark finish charging contact consisting of a reduced Schottky junction formed at a semiconductor-metal interface. The Schottky junction is reduced by using co-deposition during a PVD process, and the dark finish charging contact includes DLC and/or tetrahedral amorphous carbon (TaC) (DLC/TaC) for lowering a junction barrier height.

In some implementations, the device comprises an MR device including a pair of smart eyeglasses, and the dark finish charging contact is located on a nose-bridge of the pair of smart glasses.

In one or more implementations, the co-deposition during the PVD process includes one of alloying or doping, and alloying comprises using Ti to achieve improving a DCR of the dark finish charging contact in a reverse direction, reducing a delta in the DCR between a forward direction and the reverse direction of the Schottky junction to nearly zero, and increasing corrosion resistance of the dark finish charging contact.

In some implementations, the alloying using the Ti is configured to form the dark finish charging contact with a color L* values within a range of about 45-70 and an a* b* chromaticity value within a range of about −5-10.

Yet another aspect of the subject technology is directed to a method including creating a dark finish coating for charging contacts on a device by reducing a Schottky junction at the metal substrate and dark finish coating interface, as well as between the charging contacts of a device and charger by using a PVD process including a co-deposition. The co-deposition includes one of alloying or doping, and alloying comprises using Ti.

In one or more implementations, the method further comprises including the dark finish charging contact DLC/TaC to lower a junction barrier height, and using the Ti is configured to achieve improving a DCR of the dark finish charging contact in a reverse polarity, reducing a delta in the DCR between a forward direction and a reverse direction of the Schottky junction to nearly zero, and increasing corrosion resistance of the dark finish charging contact.

In some implementations, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

Aspects of the subject matter described in this disclosure can be implemented to realize one or more of the following potential advantages. The described techniques may be implemented to support a range of benefits and significant advantages of the disclosed eye tracking (ET) system. It should be noted that the subject technology enables fabrication of a depth-sensing apparatus that is a fully solid-state device with small size, low power, and low cost.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise”is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method comprising:
creating a dark finish coating on charging contacts of a device by:
reducing a first Schottky junction at an interface of a metal substrate of the charging contacts and the dark finish coating; and
reducing a second Schottky junction between the charging contacts of the device and a charger,
wherein:
the first Schottky junction and the second Schottky junction include a semiconductor-metal interface, and
reducing the first Schottky junction and the second Schottky junction include using co-deposition during a physical vapor deposition (PVD) process.

2. The method of claim 1, wherein the device comprises a mixed reality (MR) device including a pair of smart eyeglasses.

3. The method of claim 1, wherein a location of a charging area includes a nose-bridge of a pair of smart eyeglasses.

4. The method of claim 1, wherein the co-deposition during the PVD process includes one of alloying or doping.

5. The method of claim 4, wherein the alloying comprises using titanium (Ti) to improve a dynamic contact resistance (DCR) in a reverse polarity.

6. The method of claim 5, wherein the alloying using the Ti is to result in forming the dark finish charging contact with a color L* values within a range of about 45-70.

7. The method of claim 5, wherein the alloying using the Ti is to result in forming the dark finish charging contact with an a* b* chromaticity value within a range of about −5-10.

8. The method of claim 1, wherein the dark finish coating on the charging contacts includes diamond-like carbon (DLC) and/or tetrahedral amorphous carbon (TaC) to start with a low Schottky junction at a semiconductor-metal interface that is further reduced.

9. The method of claim 1, further comprising expanding color options for the dark finish coating on the charging contacts through one of a material color tuning or an interference coating process.

10. The method of claim 9, further comprising performing the interference coating process including layered DLC/TaC deposition.

11. The method of claim 1, further comprising creating glossy and matte finishes for the dark finish coating on the charging contacts by depositing DLC/TaC via a PVD process through alloying with Ti.

12. The method of claim 1, further comprising reducing a delta in DCR between a forward direction and a reverse direction of the first Schottky junction and the second Schottky junction to nearly zero by depositing DLC/TaC via a PVD process through alloying with Ti.

13. The method of claim 1, further comprising increasing corrosion resistance of the dark finish coating on the charging contact by depositing DLC/TaC via a PVD process through alloying with Ti.

14. The method of claim 13, wherein the increased corrosion resistance comprises resistance to sweat for a period longer than about 360 hours, and resistance to wet charging for a period up to 1 hour.

15. A device, comprising:
a charging area including a dark finish charging contact comprising:
a Schottky junction formed at a semiconductor-metal interface including a metal substrate and a dark finish coating of the dark finish charging contact, wherein:
the Schottky junction is reduced by using co-deposition during a PVD process, and
the dark finish coating on the dark finish charging contact includes DLC/TaC for a reduced junction barrier height.

16. The device of claim 15, wherein the device comprises an MR device including a pair of smart eyeglasses, and the dark finish charging contact is located on a nose-bridge of the pair of smart glasses.

17. The device of claim 15, wherein the co-deposition during the PVD process includes one of alloying or doping, and alloying comprises using Ti to achieve:
improving a DCR of the dark finish charging contact in a reverse direction;
reducing a delta in the DCR between a forward direction and the reverse direction of the Schottky junction to nearly zero; and
increasing corrosion resistance of the dark finish charging contact.

18. The device of claim 17, wherein the alloying using the Ti is configured to form the dark finish charging contact with a color L* values within a range of about 45-70 and an a* b* chromaticity value within a range of about −5-10.

19. A method comprising:
creating a dark finish coating on charging contacts of a device by:
reducing a first Schottky junction at a semiconductor-metal interface between a metal substrate and a dark finish coating of the dark finish coating on the charging contacts; and
reducing a second Schottky junction at a location of a charging area,
wherein:
the first and second Schottky junctions are reduced using a PVD process including a co-deposition, and
the co-deposition includes one of alloying or doping, and alloying comprises using Ti.

20. The method of claim 19, further comprising including in the dark finish charging contact DLC/TaC to lower a junction barrier height, and using the Ti is configured to achieve:
improving a DCR of the dark finish charging contact in a reverse polarity;
reducing a delta in the DCR between a forward direction and a reverse direction of the first Schottky junction and the second Schottky junction to nearly zero; and
increasing corrosion resistance of the dark finish charging contact.
